(19) United States
(12) Patent Application Publication
(10) Pub. No.: US 2019/0267161 A1
(43) Pub. Date: Aug. 29, 2019

(54) Electric Conductor Comprising Multiple Filaments In A Matrix

(71) Applicant: Siemens Aktiengesellschaft, Muenchen (DE)

(72) Inventor: Tabea Arndt, Erlangen (DE)

(73) Assignee: Siemens Aktiengesellschaft, Muenchen (DE)

(21) Appl. No.: 16/307,937

(22) PCT Filed: May 18, 2017
(86) PCT No.: PCT/EP2017/061913

§ 371 Date: Dec. 6, 2018

(30) Foreign Application Priority Data
Jun. 10, 2016 (DE) 10 2016 210 268.0

(51) Int. Cl. H01B 12/10; H02K 3/30; H02K 3/34; H02K 15/12; H01F 27/28; H01F 27/32; H01B 1/02; H02K 1/22; H02K 1/12

(52) U.S. Cl. CPC H01B 12/10; H02K 3/30; H02K 3/34; H02K 15/12; H02K 1/12; H01F 27/323; H01B 1/023; H02K 1/22; H01F 27/2823

(57) ABSTRACT

Various embodiments may include an electric conductor for producing a stator winding of a stator of an electric machine comprising: a plurality of filaments of a material normally conductive at 4.2 K; and a normally conductive matrix material. The plurality of filaments are embedded in the matrix material to form a monolithic composite. The matrix material is more electrically resistive than the filaments.

### CROSS-REFERENCE TO RELATED APPLICATIONS

This application is a U.S. National Stage Application of International Application No. PCT/EP2017/061913 filed May 18, 2017, which designates the United States of America, and claims priority to DE Application No. 10 2016 210 268.0 filed Jun. 10, 2016, the contents of which are hereby incorporated by reference in their entirety.

### TECHNICAL FIELD

The present disclosure relates to electric machines. Various embodiments may include an electric conductor for winding a coil of a stator of an electric machine, a composite conductor having a plurality of such conductors, and/or an electric machine having a stator winding with at least one such conductor.

### BACKGROUND

In electric machines the stator windings are typically wound from normally conductive electric conductors. This is typically also the case when superconducting materials are used in the windings of the rotor since the use of superconductors in the stator is usually not advantageous as a result of the generally relatively high alternating current losses. The electric conductors of the normally conductive stator windings may include a highly conductive material, e.g. copper or aluminum or an alloy as conductor material, wherein usually a plurality of individual wires are twisted to form a common conductor strand (braid). The mechanical strength of such a cable structure is obtained in this case both from the mechanical properties of the individual wires and also due to the friction or the movement resistance between the individual braids. As a result, the mobility of the individual conductor sections with respect to one another is severely restricted. Between the individual conductors there are intermediate spaces, which either remain free or can be filled with an additional electrically insulating solid material (for example, epoxy resins, varnishes, polyimides). The individual conductors can also be flushed with a fluid cooling medium for better heat removal, for example, by an oil having good thermal conductivity and/or good thermal capacity.

The alternating current losses which occur during operation of such an electric machine—in particular the proportion of the eddy current losses—are decisively influenced in the stator by the thickness of the individual conductors used. In order to reduce the alternating current losses, it is desirable to keep the individual conductor diameter as small as possible. At the same time, a high fill factor of the conductive material of the individual conductors is desirable so that the space requirements of the stator winding(s) does not become unnecessarily high. The weight of the stator winding(s) should also not be increased by an undesirably high proportion of material surrounding the individual conductors.

It can be advantageous to also cool the stator windings in an electric machine to a cryogenic temperature (in particular when using a cryogenic superconducting rotor) even when these are normally conductive. As a result of such cooling, a very low resistance is obtained in the metallic individual conductors. A particularly suitable material for this intended use is aluminum, since in particular in very high purity this has a particularly high residual resistance ratio and therefore a very high conductivity at low temperature.

Since aluminum is only mechanically deformable to a very restricted extent (yield strength of pure aluminum <=17 N/mm²), it has hitherto not been possible however to produce twisted conductors (braids) with aluminum strands/individual conductors each having a diameter of only a few microns or to use these in the stator windings of electric machines. The tensile strength of individual conductors and cables made of such thin aluminum strands/individual conductors is not sufficiently high to enable a manufacture of stator windings with the tensile stresses typically applied for the winding. For example, the tensile stress can lie in the range of 35 to 200 N/mm² during the manufacture of such windings.

### SUMMARY

The teachings of the present disclosure may be embodied in an electric conductor which overcomes the said disadvantages. In particular, an electric conductor may be suitable for the production of braids and/or stator windings in electric machines, which has a low Ohmic resistance, in particular at cryogenic temperature, and which at the same time has low alternating current losses. As an example, some embodiments may include an electric conductor (1) for producing a stator winding (34) of a stator (33) of an electric machine (31), comprising a plurality of filaments (3) of a material that is normally conductive at 4.2 K, wherein these filaments (3) are monolithically embedded in an electrically more highly resistive, normally conducting matrix (5).

In some embodiments, the material of the filaments (3) has aluminum as main component.

In some embodiments, the material of the filaments (3) is highly pure aluminum, which has a residual resistance ratio of at least 1000.

In some embodiments, the material of the matrix (5) has a higher tensile strength than the material of the filaments (3).

In some embodiments, the monolithic composite (3, 5) as a whole has a tensile strength of at least 10 N/mm².

In some embodiments, the monolithic composite is produced between the filaments (3) and the matrix (5) by joint mechanical forming.

In some embodiments, the material of the normally conductive matrix (5) comprises a copper and/or aluminum alloy and/or consists of such an alloy.

In some embodiments, the specific conductivity of the material of the matrix (5) lies between 1×10⁻⁷ Ωm and 2×10⁻⁶ Ωm.

In some embodiments, the individual filaments (3) inside the conductor (1) are at least partially twisted with respect to one another.

In some embodiments, the number of filaments (3) is at least 120.

In some embodiments, the diameter of the individual filaments (3) is at most 10 μm.

In some embodiments, the individual filaments (3) inside the composite are each encased with a barrier layer (7), wherein the material of this barrier layer (7) is electrically more highly resistive that the material of the surrounding matrix (5).

As another example, some embodiments may include a composite conductor (21) comprising a plurality of electrical conductors (1) as described above, which are stranded with respect to one another.

As another example, some embodiments may include an electric machine (31) having a rotor (37) and a stator (33), wherein the stator (33) has at least one stator winding (34) with at least one electric conductor (1) as described above.

As another example, some embodiments may include a method for producing an electric conductor (1) as described above, characterized by at least one process step in which the matrix (5) and the filaments (3) run through a common mechanical forming, wherein a monolithic composite is formed between the filaments and the matrix.

### BRIEF DESCRIPTION OF THE DRAWINGS

The teachings herein are described hereinafter by means of some exemplary embodiments with reference to the appended drawings in which:

FIG. 1 shows a schematic diagram of an electric conductor incorporating teachings of the present disclosure;

FIG. 2 shows a schematic diagram of an electric conductor incorporating teachings of the present disclosure;

FIG. 3 shows a schematic diagram of an electric conductor incorporating teachings of the present disclosure;

FIG. 4 shows a schematic diagram of a composite conductor comprising a plurality of such conductors;

FIG. 5 shows a schematic diagram of an electric machine with stator windings comprising such conductors;

FIG. 6 shows a schematic diagram of a pressing device for carrying out a method of manufacture; and

FIG. 7 shows an exemplary sequence diagram for a method of manufacture incorporating teachings of the present disclosure.

### DETAILED DESCRIPTION

Electric conductors incorporating the teachings herein may be suitable for winding a coil of a stator of an electric machine. An example electric conductor comprises a plurality of filaments of a material that is normally conductive at 4.2 K, wherein these filaments are monolithically embedded in an electrically more highly resistive, normally conducting matrix. A conductor which is suitable for producing a stator winding should be understood in the present context in particular as a conductor which withstands a tensile stress of at least 35 N/mm² along its longitudinal direction. Since this is a monolithic conductor, the filaments here take on the task of the individual conductors in a braid.

In some embodiments, the material of the matrix may be electrically more highly resistive than the material of the filaments, in particular in the transverse direction of the monolithic conductor from filament to filament. The latter can also be achieved by using more highly resistive barriers inside the matrix. This property of comparatively higher resistivity may in particular apply at an operating temperature of the electric machine, which, for example, can lie below 78 K, in particular at 20 K. Regardless of the ratio of the specific resistivities at room temperature, in any case at 20 K the material of the matrix should have a higher specific resistance than the material of the filaments. This has the result that the current flow in the conductor at least at 20 K takes place substantially through the filaments. The alternating current losses are then significantly reduced compared with a conductor consisting of a uniformly conductive material due to the comparatively less conductive matrix arranged between the highly conductive filaments.

In some embodiments, both the material of the filaments and also the material of the matrix may be normally conductive at a temperature of 4.2 K (i.e. at the boiling point of liquid helium). At an operating temperature which lies in the cryogenic range but above the boiling temperature of liquid helium, the electric conductor for the stator winding may therefore be normally conductive. It is therefore suitable for a normally conductive stator winding of an electric machine. Even if the material should be superconducting at even lower temperatures, the conductor is suitable for a normally conductive stator winding of an electric machine, whose stator is operated in a temperature range above 4.2 K. For example, the operating temperature of the stator can lie between 4.2 K and 78 K, in particular in the vicinity of about 20 K.

The formulation that the filaments are embedded “monolithically” in the matrix means that filaments and matrix are present together in a fixed composite, wherein no substantially empty intermediate spaces are formed between the filaments and the matrix in the current transport direction and the filaments cannot be moved (not even in sections) towards the surrounding matrix material. On the contrary, filaments and matrix together should form such a mechanically fixed composite as if they had been produced from one casting. Here however, it should not be excluded that an additional layer can also be present between the individual filaments and the surrounding matrix, as will be described as an example further below. In such a case, this additional layer may in turn form a monolithic composite both with the filament encased thereby and also with the surrounding matrix. The entire composite of filaments, matrix, and optional intermediate layer may therefore be as if from one casting with regard to the mechanical strength properties.

In some embodiments, due to the formation of the monolithic composite, the mechanical strength is substantially determined by the strength properties of the matrix material. It is therefore possible to use very fine filaments in the conductor, whose own mechanical strength would not be sufficient to produce such small-diameter filaments and for the tensile stresses during the winding and use of stator windings. However, the use of particularly fine filaments may achieve a particularly significant reduction in the alternating current losses. With the conductor described herein, the requirements of high strength and low alternating current losses can therefore be achieved simultaneously when used in a stator winding.

In some embodiments, a composite conductor comprises a plurality of electric conductors incorporating the teachings herein, which are twisted with respect to one another. The two or more conductors can therefore be arranged twisted about the central axis of the superordinate composite conductor, for example, in the manner of conventional wire braids. Such a structure makes it possible to form a larger composite conductor, with a simultaneous reduction in the alternating current losses compared to a non-twisted arrangement of the individual conductors. However, the arrangement in a flat cable, e.g. in Roebel or Rutherford cable geometry, is also possible.

In some embodiments, an electric machine comprises a rotor and a stator. The stator has at least one stator winding with at least one electric conductor according to the invention. The advantages of the composite conductor incorporating the teachings herein and the electric machine are obtained similarly to the described advantages of the electric conductor described above.

In some embodiments, a method of manufacture is used to produce an electric conductor described above. The method may include at least one process step in which the matrix and the filaments pass through a joint mechanical forming, wherein a monolithic composite is formed between the filaments and the matrix. With such a method, a “monolithic composite” can be produced in a particularly simple manner since during the joint mechanical forming, a firm mechanical bond is already formed between the filaments and the matrix during the production of the conductor (so-called “bond” or “bonding”). In particular in the case of metal materials of the filaments and the matrix, the production of a superordinate metal composite can be achieved by a joint mechanical forming, the external strength of which is substantially determined by the strength of the matrix material surrounding the filaments. In such a superordinate metal composite, the individual filaments are no longer movable with respect to the surrounding matrix.

Thus, the material of the filaments can have aluminum as main component. In particular, the filament material can comprise highly pure aluminum. Generally aluminum has the advantage of a high residual resistance ratio. With increasing purity of the aluminum, this residual resistance ratio becomes particularly large. Thus, the material of the filaments can be highly pure aluminum. This can advantageously be so pure that it has a residual resistance ratio of at least 1000. The residual resistance ratio should be understood in the present context as the ratio of the resistance of a material at 293 Kelvin in relation to its resistance at 4 Kelvin. In some embodiments, the residual resistance ratio can even be above 10000. A range between 1000 and 20000 may be possible for highly pure aluminum. For this purpose, the purity of the aluminum in the filaments can be at least 5N, in other words the substance purity can be at least 99.999%. In some embodiments, the material of the matrix may have a higher tensile strength than the material of the filaments. By this means, the monolithic composite of matrix and filaments has a particularly high tensile strength, which makes it easier to use the electric conductor to produce stator windings of electric machines. However, even when the matrix material has a tensile strength comparable to or even lower than the filament material, due to the monolithic embedding of the filaments in the matrix material, an improvement in the strength of the electric conductor (compared to a loose composite of filaments) and/or smaller filament diameters can be achieved. This is because the cross-sectional area of the entire composite is decisive for the tensile strength of the electric conductor according to the invention.

On the other hand, the tensile strength of a conventional, only loosely twisted multifilament conductor can be limited by the tensile strength of those individual filaments on which the strongest tensile force acts locally in the cable strand. For this however, only the cross-sectional area of the individual conductor is decisive. Due to the configuration of the monolithic composite, therefore quite generally the mechanical tensile strength can be increased to such an extent that tensile stresses relative to the cross sectional area of the conductor of at least 35 N/mm², in particular at least 50 N/mm² or even at least 100 N/mm² can be withstood by the entire conductor. The tensile strength (yield strength) should be understood generally here as that parameter which is designated in English linguistic usage as “yield stress” or “tensile elastic limit”. In some embodiments, the monolithic composite can be achieved between the filaments and the matrix by joint mechanical forming.

The material of the normally conductive matrix may comprise a copper alloy and/or an aluminum alloy or can even completely consist of such an alloy. For example, such an alloy can comprise a copper-nickel alloy, a copper-chromium alloy, or an aluminum-iron-cerium alloy (such as, for example, Alcoa CU78). Generally compared to pure copper or aluminum, for the described application such alloys have a higher specific resistance with simultaneously high tensile strength.

The specific resistance of the material of the matrix may lie above 1×10⁻⁷ Ωm. In particular, it can lie between 1×10⁻⁷ Ωm and 2×10⁻⁶ Ωm. With such a high specific resistance, the current flow during operation of the stator winding takes place substantially through the filaments. The said resistance values should in this case be in particular the resistance values at an operating temperature of the electric machine, which can advantageously lie below 78 K, in particular at 20 K.

In some embodiments, the ratio of the specific conductivity of the material of the filaments to the specific conductivity of the material of the matrix at the operating temperature of the machine can be at least 100.

In some embodiments, the individual filaments inside the conductor can be at least partially twisted with respect to one another. This may reduce the alternating current losses compared to a conductor with straight-running filaments. In particular, all the filaments of the electric conductor can be twisted around a central axis of the conductor. The pitch, i.e. the spatial twisting period can be between 2 and 10 mm.

In some embodiments, the number n of the individual filaments in the electric conductor may be at least 120, in particular at least 500, and/or at least 1000. By means of such a fine filamentization of the conductor, a reduction in the alternating current losses can be achieved. For example, the number n of filaments in an electric conductor can lie between 120 and 20000, in particular between 1000 and 5000.

In some embodiments, the filaments in the conductor can be arranged according to the pattern of a centered hexagon. If the central place of such an arrangement is occupied by a conductor, the number n of conductors is then obtained according to the general formula

n=3i²+3i+1, (Formula 1)

wherein i is the number of concentric shells around the central place. The corresponding number sequence is therefore
n=7, 19, 37, 61, 91, . . .

If the central space of such an arrangement is not occupied by a conductor but remains free, the number n of conductors is instead obtained according to the general formula

n=3i²+3i, (Formula 2)

wherein i is again the number of concentric shells around the now vacant central space. The corresponding number sequence is therefore
n=6, 18, 36, 60, 90, . . .

In a twisted embodiment of the electric conductor, the central space may remain free since then there is no central conductor which would only be twisted about itself. In this case therefore, the number sequence according to Formula 2 should be used and the number of filaments can be an element of this number sequence.

In some embodiments, the number n of filaments can be a product of two or more elements of the number sequences according to Formula 1 and/or Formula 2. This may hold when the individual filaments are arranged in groups, wherein the individual filaments of one group are arranged in the manner of a centered hexagon and the individual groups of filaments are in turn arranged among one another in the manner of centered hexagons. The nesting depth of such groups can also be greater than two one, wherein then correspondingly more elements of the above-specified number series are multiplied by one another in order to obtain the total number of filaments.

In some embodiments, the diameter of the individual filaments is at most 10 μm, in particular at most 5 μm. For example, the diameter can lie between 3 μm and 10 μm. Such a fine structuring may achieve a significant reduction in the alternating current losses compared to undivided conductors or conductors having thicker filaments.

In some embodiments, the individual filaments can, for example, have a circular cross section. In some embodiments, they can have a rectangular, hexagonal, or different polygonal cross section, optionally also with rounded corners. Due to the production of the electric conductor by means of a joint mechanical forming of the filaments and the matrix, an original symmetric shape of the filaments can also be deformed during this step. A particularly high fill factor can be achieved with an approximately hexagonal shape of the filaments.

Regardless of the precise configuration of the filaments, the electric conductor can generally have a fill factor of filament material of at least 20%. In particular, this fill factor can be at least 30%, for example between 30% and 60%, and/or above 60%. With a correspondingly high fill factor, the space requirement for the stator windings in the electric machine is relatively small. In some embodiments, the diameter of the entire electric conductor with a plurality of filaments in a matrix may lie between 0.5 mm and 3 mm.

In some embodiments, the individual filaments inside the monolithic composite are each encased with a barrier layer, wherein the material of this barrier layer may be electrically more highly resistive that the material of the surrounding matrix. Here also the said relationship applies between the electrical properties again in particular at the operating temperature of the electric machine, i.e. for example at 20 K. The barrier layer is therefore both less electrically conductive than the filaments and also less conductive than the matrix. It therefore serves as an electrical barrier between filaments and matrix. In some embodiments, the resistivity of the matrix material is not sufficient for the desired electrical separation of the filaments. The electrical separation can then be reinforced by the barrier layer, wherein the mechanical properties (in particular the tensile strength) of the entire electric conductor are as before (co-)determined by the properties of the matrix material. Thus, the matrix material can be selected with a view to the desired mechanical strength and deformation properties and the electrical separation can be accomplished independently of this choice of material.

In some embodiments, such a barrier layer can comprise steel, chromium, a copper alloy, a ceramic, and/or a plastic (for example, a varnish). The thickness of such a barrier layer can, for example, lie between 0.5 μm and 20 μm, in particular between 0.5 μm and 3 μm. In order to achieve a high fill factor for the filament material, the thickness of the barrier layer may be less than the diameter of the filaments. In principle however, it is also possible that the thickness of the barrier layer is greater than the filament diameter, for example, if the fill factor is less important than the most extensive possible electrical insulation between the individual filaments. In some embodiments, the barrier layer can generally also act as a diffusion barrier between the matrix and the filaments, for example, in order to suppress a chemical contamination of the highly pure filaments by the material of the matrix during the mechanical forming process (which can generally also take place at elevated temperature).

In some embodiments, the electric conductor can comprise an interior coolant channel. During operation of the electric machine, a fluid coolant can be passed through this channel for cooling the stator windings. Such a coolant channel can, for example, be arranged at a central point in the conductor. This can be the above-mentioned unoccupied central space of a centered hexagonal arrangement of filaments or groups of filaments. The cross section of such a coolant channel can, for example, be hexagonal or round, wherein this (original) form can also be deformed by the manufacturing process, in particular by a joint mechanical forming of the components of the electric conductor.

In some embodiments, the electric conductor can be provided with an outer sheath to increase its mechanical strength and/or the electrical contact resistance. Suitable materials for such an outer sheath are, for example, chromium, nickel, and/or anodized aluminum.

In some embodiments, a composite conductor has a plurality of conductors twisted with respect to one another, these individual conductors can each be straight in themselves, i.e. untwisted. A twisting of the individual conductors “into themselves” is not necessary since these are still twisted with respect to one another. In some embodiments, the individual electric conductors in the twisted structure of the composite conductor can nevertheless already be twisted “into themselves”.

In some embodiments, the electric machine can comprise a stator winding, in which one or more individual electric conductors according to the invention are wound to form a coil. In some embodiments, the electric machine can however also comprise one or more composite conductors as described above.

In some embodiments, an electric machine includes a rotor rotatably mounted relative to the stator by means of a rotor shaft. The rotor can in particular be a rotor having at least one superconducting winding. In some embodiments, the machine comprises a cooling system in order to cool the superconducting winding to an operating temperature below the transition temperature of the superconductor. The superconductor may comprise a high-temperature superconductor, for example, magnesium diboride, a bismuth-containing first-generation high-temperature superconductor, or a second-generation high-temperature superconductor, in particular a material of the type REBa₂Cu₃Oₓ (REBCO for short), wherein RE stands for a rare earth element or a mixture of such elements.

In some embodiments with a superconducting rotor, the electric machine can be designed for an operating temperature of the stator winding(s) below 78 K, in particular in the range of 20 K. Rotor and stator windings can therefore be arranged in a cryogenic region of the machine to be cooled jointly. They can be insulated towards the warm external surroundings in a common cryostat. This can facilitate the construction of the machine since rotor and stator can lie close to one another and need not be thermally decoupled from one another. Since the alternating current losses in the stator are kept low due to the structure of the conductor, the heat to be removed from the stator is also low and the cooling system of the electric machine can be designed overall for relatively small quantities of heat to be removed. Since rotor and stator need not be cooled separately, the number of cooling units can be reduced and/or the space requirement for the cooling can be reduced. Overall, the electric machine can be designed to be smaller and lighter and a higher power density can be achieved. These details may be valuable to aircraft with electric drives, in which the power density of the motors used for the drive and of the generators located on board must be extremely high.

In some embodiments, a method of manufacture can be configured similarly to the known methods for manufacturing monolithic multifilament low-temperature superconductors. Such a method is described, for example, for niobium-titanium (NbTi) and niobium-tin superconductors (Nb₃Sn) in the publication “Fabrication and Application of NbTi and Nb₃Sn Superconductors” by H. Krauth (NIOBIUM; SCIENCE & TECHNOLOGY, pp 207-219, 2001). In the embodiments of the method, the niobium-based low-temperature superconductors described there may be replaced by the normally conducting filament material. In this case, the materials described further above can be used both for the filament material and/or for the matrix material.

In some embodiments, the process step of joint mechanical forming of matrix and filaments can comprise a step of drawing, rolling and/or extrusion molding (also known under the term of co-extrusion). In the extrusion molding step, an extrusion billet can be pressed by a stamper. This extrusion billet can comprise an extrusion molding of matrix material and elongate rod elements of filament material (or at least having a fraction of filament material) can be introduced into this extrusion molding before the pressing step. To this end, the extrusion molding can be provided for example with elongate holes. The extrusion molding and the rod elements are then pressed jointly by the stamper, whereby on the one hand a reduction in the cross-sectional area and on the other hand the formation of a monolithic composite between the extrusion molding and the rod elements are brought about.

The reduction in the cross-sectional area in such an extrusion molding step can for example be between 20% and a factor of 10, in particular between 50% and a factor of 5. The reduction is determined by the shape of the stamper. In order to bring about an even greater reduction in the diameter, a plurality of such extrusion molding steps or also cold forming steps (conventional drawing through what is known as a drawing die) can be carried out successively. In this case, the formed first intermediate body may undergo a thermal treatment between the individual forming steps. For example, the first intermediate body (or a relevant partial region thereof) can run between the different forming steps through a furnace. During such a thermal treatment, a recrystallization in the intermediate body is brought about at least partially, with the result that the suitability of the first intermediate body for a renewed forming is improved.

The diameter of the extrusion molding used can, for example, be between 60 mm and 200 mm, and the diameter of the rod elements introduced therein (subsequent filaments) can, for example, be in the range between 1 mm and 10 mm. After passing through several forming steps, a conductor having a diameter of, for example, 5 mm to 50 mmm can be formed with such starting elements.

If in this method the rod elements initially introduced into the extrusion molding only consist of filament material and after the reduction become the individual filaments, the filament diameter is predefined by the diameter of the rod elements and the reduction ratio. In this embodiment of the method, the filaments therefore cannot be arbitrarily fine. In order to obtain very fine filaments, the method can comprise a plurality of internested subchains of forming steps. In the first subchain, for example, pure filament material (or filament material only encased with one barrier layer) is used in the rod elements. Here in any case the rod elements still contain no matrix material. A first forming body is formed as the product of the first subchain of forming steps, which forming body contains a plurality of filaments in the monolithic composite with the extrusion molding of matrix material.

In a second subchain of forming steps, a second extrusion molding of matrix material can now be used, whose bores are filled with a plurality of second rod elements. In this case, the products of the first subchain of the method are used in each case as second rod elements, in other words a plurality of first forming bodies. These rod elements of the first forming body then contain therefore both matrix material and also filament material.

As a result of the described nesting of the chains of extrusion molding steps, a stronger reduction in the original rod elements of the first step substantially formed from filament material can be achieved. The nesting depth can also be greater than two with the result that particularly fine filaments and particularly large numbers of filaments can then be formed accordingly in a conductor.

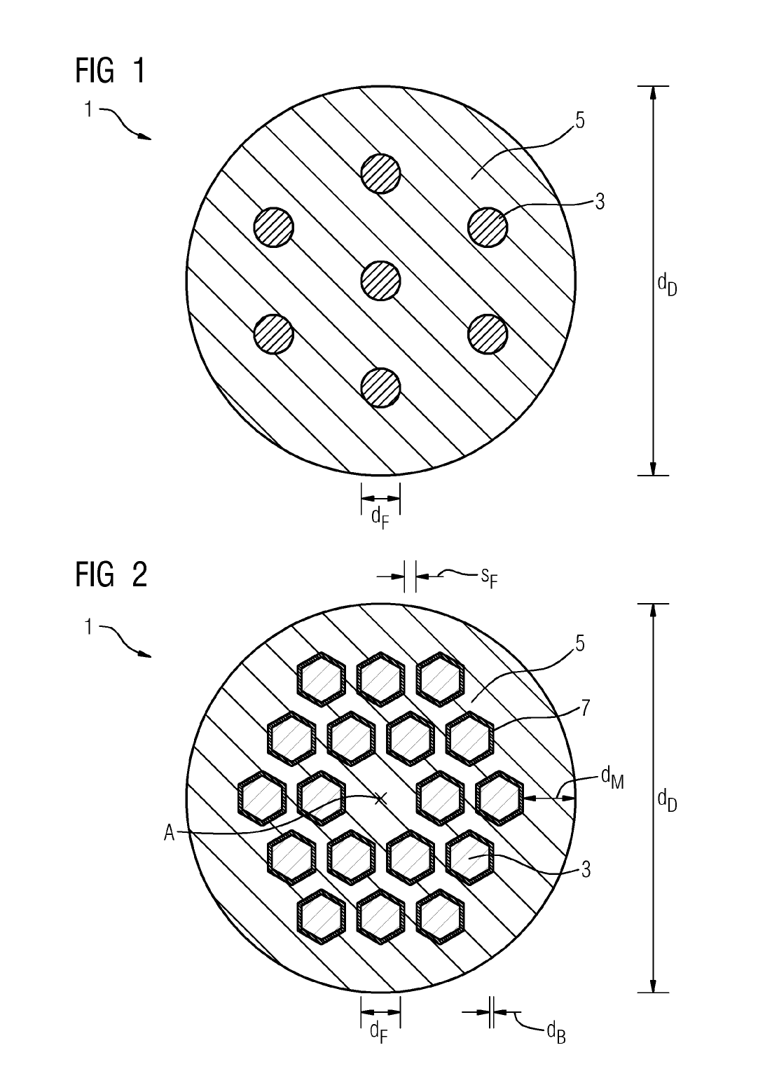

FIG. 1 shows a schematic cross-sectional view of an electric conductor 1 according to a first exemplary embodiment. Shown is a conductor 1, in which a plurality of filaments 3 are embedded monolithically in a surrounding matrix 5. The conductor diameter is denoted by d_{D} and the filament diameter is denoted by d_{F}. These dimensions can, for example, assume the values described further above. FIG. 1 shows only as an example seven filaments which, however, can also be representative for a substantially larger number of filaments, in particular at least 120 filaments in an electric conductor 1. These filaments can be embedded in the matrix in a hexagonal arrangement such as is depicted for the seven filaments in FIG. 1. In the case of larger numbers of filaments, the filament arrangements can also be divided into subgroups each arranged in a hexagonal manner among one another. The cross-sectional shape of the individual filaments is in this case not restricted to the circular shape shown. The filaments can also have any other cross-sectional shapes, for example, hexagonal cross sections. The conductor 1 can generally be twisted about its longitudinal axis A.

FIG. 2 shows another example of an electric conductor 1 again in schematic cross section. Here also a plurality of filaments 3 are embedded monolithically in a matrix 5 in a hexagonal configuration. For example, for simplicity here only 18 filaments are shown, wherein also this number is again only representative and can stand for a substantially higher number of filaments. It is essential for the example that a hexagonal arrangement exists and that the central region of the conductor 1 is not occupied by filaments. During a twisting of the electric conductor 1 about its own longitudinal axis A, there is no filament 3, which undergoes no change in place during the twisting. In other words, in such a configuration with the center remaining free, all the filaments 3 are arranged so that they change their places during a twisting, with the result that the alternating current losses in the conductor 1 are reduced.

A further difference of the electric conductor 1 in FIG. 2 from the conductor of FIG. 1 is that the filaments 3 are each encased by a barrier layer 7. This barrier layer 7 has a higher resistance than the matrix material (and therefore also than the filaments 3). It therefore acts as an additional electrical barrier between the filaments 7, which helps to reduce the eddy current losses in the conductor 1. In addition, the barrier layer can also act as a chemical barrier in order to reduce any diffusion between the filaments 7 and the material of the matrix 5. As a result, for example, a high purity of the material of the filaments 7 can be preserved. The thickness of the barrier layer d_{B} can in particular have the advantageous values mentioned further above.

The fill factor of the material of the filaments 3 relative to the cross-sectional area of the electric conductor 1 can generally be at least 20%, at least 30%, and in particular even at least 60%. Such high fill factors can be achieved, for example by the spacings s_{B} between the individual neighboring filaments being at most 20 μm. In this case, the spacing d_{M} of the outer filaments 3 to the outer edge of the matrix 5—i.e. the thickness of the matrix casing surrounding the filaments overall—is greater than the average spacing s_{F} of neighboring filaments. In the case of large numbers of filaments (which in particular can be substantially larger than those shown as an example in the figures), the influence of this surrounding casing on the fill factor of filament material is nevertheless advantageously small. Thus, the thickness d_{M} of this matrix casing can, for example, be less than 5% of the diameter d_{D} of the conductor 1, for example, it can be between 1.5% and 5% of this diameter.

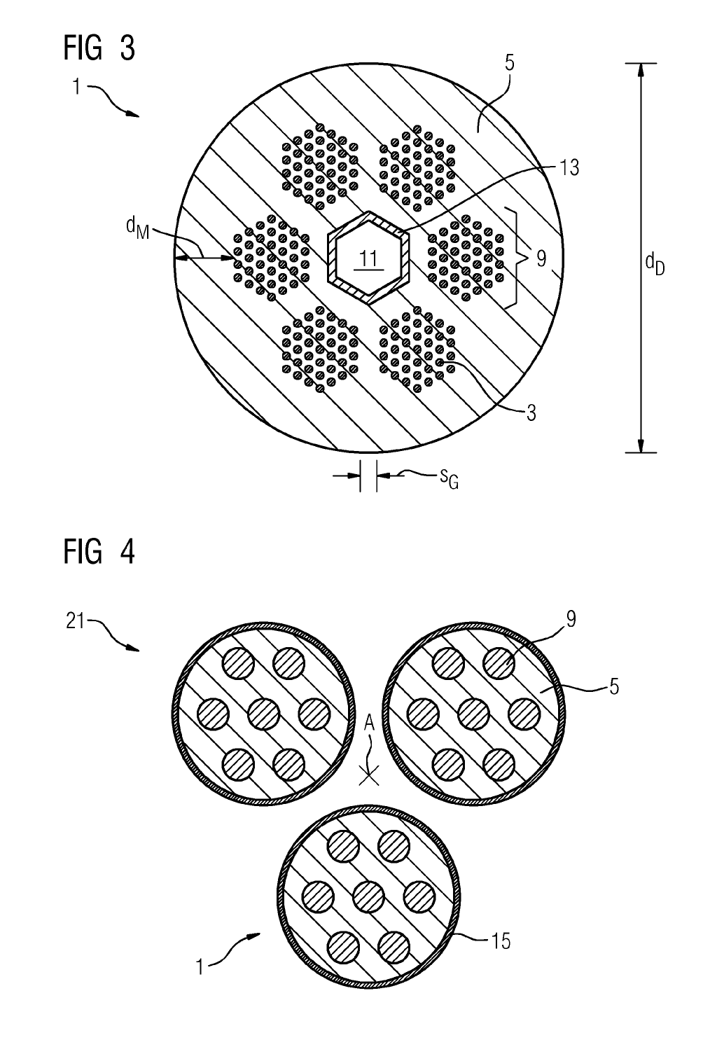

FIG. 3 shows another embodiment of an electric conductor 1 in schematic cross-section. In this conductor, the individual filaments 7 are arranged in regular groups 9, which are each composed of hexagonally arranged filaments 7. In FIG. 3 for example, 37 filaments 3 per group 9 are shown and six such groups are arranged around a center unoccupied by filaments. In the example shown 222 filaments are obtained from this grouping. However, any other numbers of filaments 3 per group 9 and of groups 9 per conductor are also possible, wherein numbers for both values can each be obtained from the hexagonal arrangements—according to formulas 1 and 2 mentioned further above. The central locations can in this case each be occupied or unoccupied. Within one group 9, for example, the center can be occupied in order to achieve a high fill factor. At the center of the conductor 1 overall, it is generally not occupied by a group 9 in order to again avoid filaments 7 without significant change of place during twisting.

In the example of FIG. 3, the center unoccupied by filaments may be filled by a coolant channel 11. The conductor 1 therefore comprises an interior channel 11, through which a fluid coolant can flow to cool the conductor. In particular, the conductor can thereby be cooled to cryogenic temperatures. The coolant can, for example, comprise liquid helium, liquid neon, liquid hydrogen, or liquid nitrogen.

In the electric conductor shown in FIG. 3, the filaments 3 can in principle either be configured similarly as in FIG. 1 without a barrier layer or they can each be encased by a barrier layer similarly as in FIG. 2. Generally, and regardless of the precise embodiment, the groups of filaments can be introduced into the matrix via a multistage nested co-extrusion process, in which in each case a plurality of first forming bodies (each having several filaments embedded in a matrix) can be used as rod elements for a further co-extrusion process. This also can optionally be repeated multiple times in order to embed a particularly large number of filaments 3 in an electric conductor 1 with limited diameter d_{D} without the reduction ratio within a continuous chain of forming steps needing to be selected to be too extreme and without the inserted rod elements needing to have too thin dimensions.

The interior coolant channel 11 shown in FIG. 3 can optionally be surrounded by a channel wall 13, the material of which differs from the material of the remaining matrix 5. Such a channel wall 13 can serve to keep the coolant channel open during a mechanical forming process. To this end, the material of the channel wall is advantageously harder than the material of the surrounding matrix. For example, a thin steel or a copper alloy or an aluminum alloy can be provided as material of the channel wall 13. In some embodiments, the channel can also be filled during forming in order to avoid a closing during forming. The filling material (e.g. a salt, e.g, NaCl) can easily be removed after the forming, for example by a solvent.

FIG. 4 shows an exemplary embodiment of a composite conductor 21 with a plurality of electric conductors 1 in schematic cross section. These electric conductors 1 may each be configured as described above and can, for example, be constructed similarly as described in connection with FIGS. 1 to 3. The individual conductors 1 are twisted with one another and thereby twisted in a spiral shape about a central axis A of the superordinate composite conductor 21. For example, in FIG. 4 for each conductor there are seven groups 9 of conductor filaments, which are arranged in a hexagonal manner among one another. Here each group 9 can comprise a plurality of filaments 3, which in particular also have a hexagonal arrangement within the group 9. Here also the arrangement of the filaments 3 in the groups 9 can be produced by multiple, nested forming of rod elements in a matrix.

The three individual electric conductors 1 of FIG. 4 have an additional outer sheath 15 around the matrix material 5, which serves to protect the individual conductors and/or for mechanical reinforcement and/or to increase the contact resistance of the conductors. Suitable materials for such an outer sheath 15 are, for example, anodized aluminum, aluminum or copper alloys, ceramic coatings, or plastic coatings.

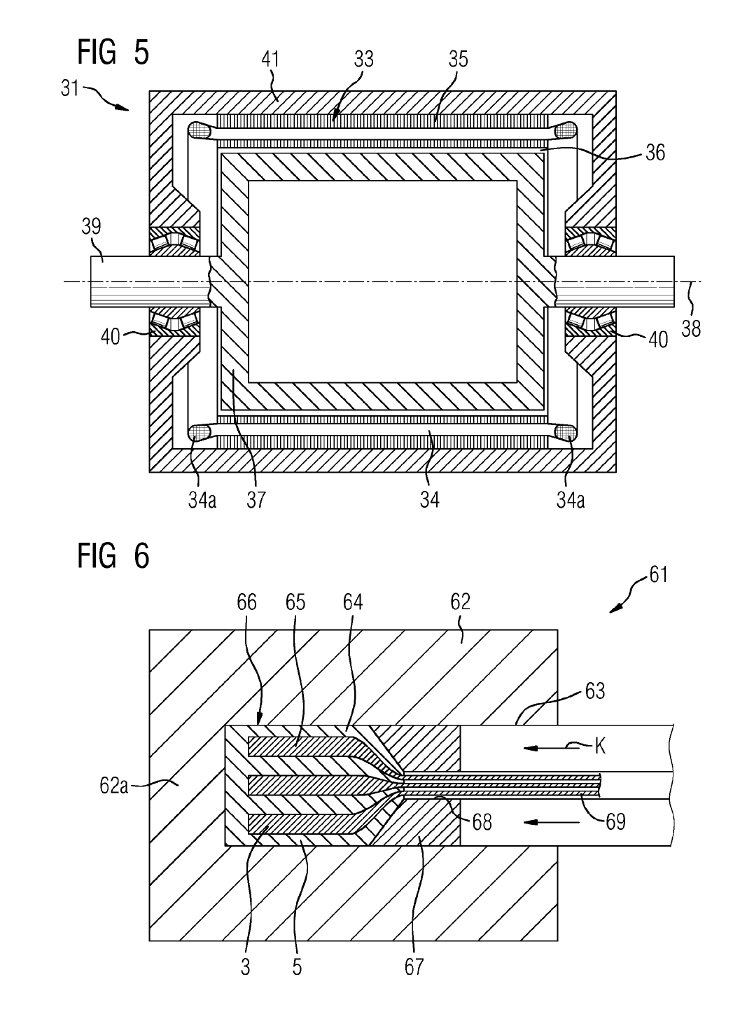

FIG. 5 shows a schematic longitudinal section of an electric machine 31 according to a further embodiment of the teachings herein. The electric machine comprises a rotor 37 and a stator 33. The rotor 37 is rotatably mounted about an axis of rotation 38 by means of a rotor shaft 39. For this purpose, the rotor shaft 37 is supported against the machine housing 41 via the bearings 40. A longitudinal section along the axis of rotation 38 is shown. The electric machine can in principle comprise a motor or a generator or also a machine, which can be operated in both modes.

The stator 33 has a plurality of stator windings 34, whose winding heads 34a extend into radially external regions. In particular, the further interior regions of the stator windings 34 between these winding heads 33 enter into electromagnetic interaction with a field of the rotor during operation of the electric machine 31. This interaction takes place via an air gap 36, which lies radially between rotor 37 and stator 33. In the example shown, the stator windings 34 are embedded in grooves of a stator sheet metal package 35 but can also be so-called “air gap windings” without a sheet metal package. Within the framework of the present invention, it is essential that the stator windings are each wound from electric conductors 1 according to the invention or from composite conductors 21 according to the invention with such conductors 1. In this case, the conductors can be constructed similarly to that described in connection with FIGS. 1 to 3. A composite conductor having a plurality of electric conductors can be constructed, for example as described in connection with FIG. 4.

The electric machine of FIG. 5 can have superconducting windings in the rotor 37. For this purpose, the rotor 37 can be cooled during operation to a cryogenic temperature, which lies below the transition temperature of the superconductor used. This operating temperature can, for example, be around 20 K. The cooling can be achieved with a cooling system not shown in detail in the diagram. The cryogenic components should additionally be thermally insulated with respect to the warm surroundings. In the exemplary embodiment shown, this thermal insulation (not shown in more detail here) lies in the outer region of the electric machine so that the stator windings 34 together with the rotor 37 are also cooled to the cryogenic temperature. For example, the machine 31 can be thermally insulated towards the outside via the housing 41. Due to the cooling of the stator 33, lower losses occur in the stator windings 34 and a smaller radial spacing can also be maintained between the rotor windings and the stator windings, which is also advantageous for the operation of the machine.

FIG. 6 shows a pressing device 61 for carrying out a method for producing a conductor 1 in schematic longitudinal section. Shown is a receiver 62, which has an interior recess 63. An extrusion billet 66 is inserted into this recess, which during passage through a pressing die 67 also arranged in the recess 63 is mechanically deformed and thereby reduced in its cross section. In order to bring about this forming process, in the example shown the pressing die 67 is pressed with a pressure force K against a pressure piece 62a of the receiver 62 shown on the left. However, it is alternatively also possible to press the extrusion billet 66 with a comparable pressure force from the left towards a stationary pressing die 67. It is only essential that the extrusion billet 66 is pressed against the pressing die 67 and is mechanically deformed on passing through a central opening 68 of the pressing die 67.

The extrusion billet 66 comprises an extrusion molding 64, which comprises matrix material and a plurality of holes produced before inserting into the receiver. These holes can, for example, be blind holes, which are closed in the region of the extrusion molding 64 shown on the left in FIG. 6. A plurality of rod elements 65 are then introduced into the holes from the open side, which rod elements can for example substantially consist of matrix material or however already comprise a plurality of filaments embedded in the matrix material. As a result of the forming in the pressing die 67, a first intermediate body 69 having reduced cross section is formed from the original extrusion billet 66.

The intermediate body this formed can in the simplest case be the finished electric conductor. However, after a first such mechanical forming step, one or more further forming steps can take place, in which further pressing steps are passed through in similar manner and in which the conductor is successively further reduced in cross section. Optionally thermal treatment steps can take place between the individual forming steps.

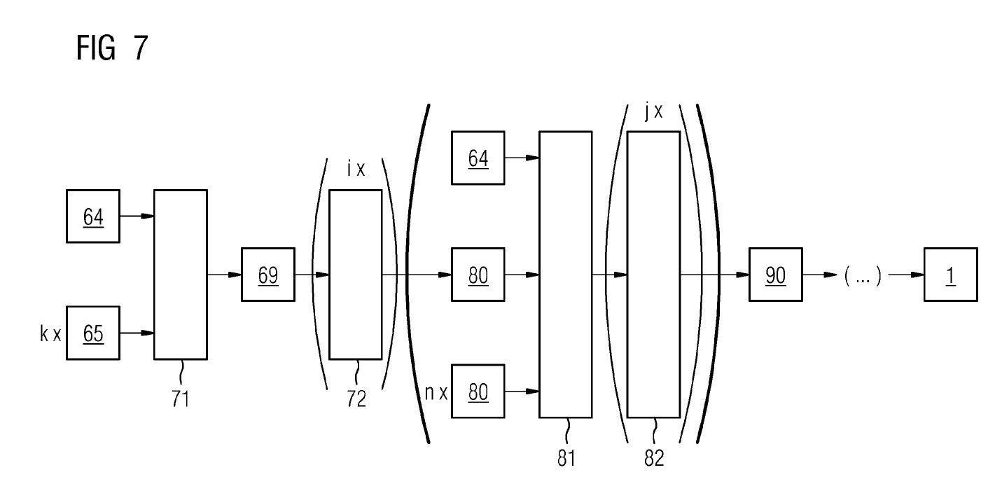

An example for a sequence of the production process incorporating the teachings herein is reproduced schematically in FIG. 7. Here optional process steps are shown in parentheses. As starting elements, an extrusion molding 64 and a plurality of rod elements are joined to form a first intermediate body 69 in a first mechanical forming step and reduced in cross section. In an optional sequence of i further mechanical forming steps 72, this first intermediate body 69 is further reduced in its cross section, so that a first forming body 80 is formed. Between the individual forming steps, thermal treatment steps can be provided in each case, which for the sake of simplicity are not shown in the figure. The first forming body 80 then comprises a plurality of filaments 7, which are embedded monolithically in the matrix material by the at least one forming step 71.

If an even larger number of filaments per conductor is desired than can expediently be achieved with such a simple forming chain, further optional process steps can be provided, which are shown in FIG. 7 in the bold parentheses. Here firstly a further extrusion molding 64 is used, which can be formed substantially from matrix material similarly to the extrusion molding of the first step. Holes are also made in this and the first forming body 80 from the previously described process chain and n further such first forming bodies 80 are introduced into these holes, similarly to the rod elements 65 of the first process step 71. In a further mechanical forming step 81 (which can take place similarly to the forming step 71), these forming bodies 80 are then again embedded monolithically in the matrix material of the new extrusion molding 64 and the cross section is reduced again.

This mechanical forming step 81 can also be supplemented by a number i of optional further forming steps 82 in order to achieve a greater reduction. Finally a second forming body 90 is formed as the product of this further chain of process steps. The electric conductor can either be formed directly from this (optionally by encasing with an outer sheath) or a further nesting of the process can take place with a sequence of further optional process steps indicated by dots whereby the second forming body 90 together with similar second forming bodies is also again introduced into a further extrusion molding and so on. This can take place repeatedly until a predefined number of filaments 3 is achieved in the finished electric conductor 1.

In the previously described process, the rod elements 65 used in the first process step 65 can either be formed from pure filament material or also from filament material encased with barrier material. The cross-sectional shapes and sizes of the holes and the rod elements can be selected freely and should only be substantially matched to one another. For an interior coolant channel either a hole can be left free or this can be equipped with a tube of the material of the described cooling channel wall 13.

What is claimed is:

1. An electric conductor for producing a stator winding of a stator of an electric machine, the electric conductor comprising:
a plurality of filaments of a material normally conductive at 4.2 K; and
a normally conductive matrix material;
wherein the plurality of filaments are embedded in the matrix material to form a monolithic composite; and
the matrix material is more electrically resistive than the filaments.

2. The electric conductor as claimed in claim 1, wherein the material comprises aluminum as main component.

3. The electric conductor as claimed in claim 2, wherein the material of the filaments comprises highly pure aluminum with a residual resistance ratio of at least 1000.

4. The electric conductor as claimed in claim 1, wherein the matrix material has a higher tensile strength than the material of the filaments.

5. The electric conductor as claimed in claim 1, wherein the monolithic composite has a tensile strength of at least 10 N/mm².

6. The electric conductor as claimed in claim 1, wherein the monolithic composite is produced by joint mechanical forming of the filaments and the matrix.

7. The electric conductor as claimed in claim 1, wherein the matrix material comprises at least one metal selected from the group consisting of: copper, aluminum, and copper/aluminum alloy.

8. The electric conductor as claimed in claim 1, wherein a specific conductivity of the matrix material is between 1×10⁻⁷ Ωm and 2×10⁻⁶ Ωm.

9. The electric conductor as claimed in claim 1, wherein the individual filaments are at least partially twisted with respect to one another.

10. The electric conductor as claimed in claim 1, wherein the plurality of filaments include at least 120 filaments.

11. The electric conductor as claimed in claim 1, wherein a diameter of the individual filaments is no more than 10 μm.

12. The electric conductor as claimed in claim 1, wherein each individual filament of the plurality of filaments is encased with a respective barrier layer;
wherein the barrier layer is more electrically resistive that the surrounding matrix material.

13. A composite conductor comprising:
a plurality of electrical conductors, each electric conductor comprising:
a plurality of filaments of a material normally conductive at 4.2 K; and
a normally conductive matrix material;
wherein the plurality of filaments are embedded in the matrix material to form a monolithic composite;
the matrix material is more electrically resistive than the filaments; and
each electrical conductor is stranded with respect to one another.

14. An electric machine comprising:
a rotor;
and a stator with a stator winding;
wherein the stator winding includes with at least one electric conductor comprising:
a plurality of filaments of a material normally conductive at 4.2 K; and
a normally conductive matrix material;
wherein the plurality of filaments are embedded in the matrix material to form a monolithic composite; and
the matrix material is more electrically resistive than the filaments.

15. A method for producing an electric conductor, the method comprising:
running a matrix material and a plurality of filaments through a common mechanical forming to form
a monolithic composite between the plurality of filaments and the matrix;
wherein the plurality of filaments comprise a material normally conductive at 4.2 K;
the matrix material is normally conductive; and
the matrix material is more electrically resistive than the filaments.
